(19) United States
(12) Patent Application Publication
(10) Pub. No.: US 2008/0149144 A1
(43) Pub. Date: Jun. 26, 2008

(54) Adjustment Apparatus for a Control Element of a Water Deflector, Method for Adjustment, and Synchronous Motor for Adjusting the Control Element

(75) Inventor: Fritz Siebachmeyer, Neukirch (DE)

Correspondence Address: LERNER GREENBERG STEMER LLP, P O BOX 2480, HOLLYWOOD, FL, 33022-2480, US

(73) Assignee: DIEHL AKO STIFTUNG & CO KG, Wangen (DE)

(21) Appl. No.: 11/962,413

(22) Filed: Dec. 21, 2007

(30) Foreign Application Priority Data
Dec. 21, 2006 (DE) DE102006061973.0

(51) Int. Cl. B08B 13/00; B08B 3/08

(52) U.S. Cl. 134/34; 134/57 R

(57) ABSTRACT

An adjustment apparatus for a control element of a water deflector in a water-bearing household appliance has an electric motor which can be actuated by a control electronics system. The water deflector has a control element for influencing the detergent circuit and the control element is driven by the motor through a transmission that transmits the rotation of the electric motor to the control element. The position of the control element is determined by a corresponding sensor. The electric motor is a single-phase synchronous motor which rotates to the left and to the right and has two connections.

### CROSS-REFERENCE TO RELATED APPLICATION

This application claims the priority, under 35 U.S.C. § 119, of German patent application DE 10 2006 061 973.0, filed Dec. 21, 2006; the prior application is herewith incorporated by reference in its entirety.

### BACKGROUND OF THE INVENTION

### Field of the Invention

The invention relates to an adjustment apparatus for a control element of a water deflector for a water-bearing household appliance. The adjustment apparatus has an electric motor which can be actuated by a control electronics system, a water deflector with a control element for influencing the detergent circuit, means for transmitting the rotation of the electric motor to the control element, and means for ascertaining the position of the control element. The invention further pertains to a method for adjusting such an adjustment apparatus and also to the utilization of a single-phase synchronous motor for adjusting the adjustment device and for controlling a control element of a water deflector for a water-bearing household appliance.

In order to be able to set the water requirement as a function of the washing program of a dishwasher, water deflectors which are provided with differently configured throughflow openings are arranged in the detergent circuit. Depending on the water requirement, the water deflector is adjusted by a specific angle of rotation, so that washing water flows through a different throughflow opening and a different quantity of water is thus provided. In order to make this possible, the water deflector is mounted in a rotationally fixed manner on a shaft which can be driven by an electric motor. A control disc which is synchronized with the water deflector and by means of which the current angle of rotation of the water deflector can be determined is likewise provided on the shaft. The electric motors used are motors which can rotate only in one direction or have been actuated such that only one direction of rotation is possible.

One disadvantage of a configuration of this type is that the throughflow states of the water deflector which are prespecified by the various angular positions of the control disc can be actuated only sequentially. Therefore, for example, the last throughflow state can be repeated only by sequentially passing through all the other throughflow states stored in the control disc. The washing process has to be interrupted during the “turning” of the control disc and the water deflector. This increases the duration of the washing program. In addition to the desire to reduce the duration of washing programs, attempts are always being made to lower costs for household appliances on account of high cost pressures.

### SUMMARY OF THE INVENTION

It is accordingly an object of the invention to provide an adjustment apparatus of a water deflector for a water-bearing household appliance, and also a method for adjusting a water deflector, and the use of a synchronous motor, which overcome the above-mentioned disadvantages of the heretofore-known devices and methods of this general type and by way of which the washing duration of washing programs can be shortened or the costs can be reduced.

With the foregoing and other objects in view there is provided, in accordance with the invention, an adjustment apparatus for a control element of a water deflector of a water-bearing household appliance, comprising:

a single-phase synchronous electric motor configured to rotate to the left and to the right and having two connections, and a control electronics system connected to and actuating said electric motor to selectively turn to the left and to the right;

a water deflector with a control element for influencing a detergent circuit in the water-bearing household appliance;

a transmission device connected for transmitting a rotation of said electric motor to said control element; and

means connected to said control electronics system for ascertaining a position of said control element.

In other words, the objects of the invention and, particularly the first-mentioned object, are achieved, with respect to an adjustment apparatus, by a control element of a water deflector of a water-bearing household appliance, with the adjustment apparatus having an electric motor which can be actuated by a control electronics system, a water deflector with a control element for influencing the detergent circuit, means for transmitting the rotation of the electric motor to the control element, and means for ascertaining the position of the control element. The electric motor according to the invention is a single-phase synchronous motor which rotates to the left and right and has two connections.

The adjustment apparatus has a control element, which influences the flow through the detergent circuit, of a water deflector and an electric motor which can be actuated by means of a control electronics system and whose rotation can be transmitted to the control element by means for transmitting the rotation. The adjustment apparatus also has means which can be used to determine the position or rotation position of the control element. The electric motor is a single-phase synchronous motor which rotates to the left and right and has two connections.

The single-phase synchronous motor which rotates to the left and right and has two connections is particularly advantageous since it is possible to reverse the direction of rotation and it is therefore not necessary to run through the entire control element in only one direction, if a throughflow state, which has just been run through for example, of the detergent circuit is once again to be set. On account of the possible reversal in the direction of rotation, it is therefore not necessary to run through an angle of rotation of virtually 360°, but it is sufficient to run through an angle of rotation of a few degrees in the opposite direction, and therefore to considerably shorten the washing program.

As an alternative to shortening the washing program duration, an electric motor which rotates more slowly can be used. A motor of this type may be smaller and therefore more cost-effective to produce. The expenditure of the motor with respect to torque is lower in the case of a slowly rotating motor. That is to say, when the motor rotates slowly, a higher torque is provided in spite of the smaller size of the motor, in order to adjust the control element.

The second-mentioned object with respect to a method for adjustment is achieved, according to the invention, by an adjustment apparatus for a control element of a water deflector for a water-bearing household appliance, with the adjustment angle of the control element being determined by a means for ascertaining the position of the control element, and with the control element being adjusted by a synchronous motor which rotates to the left and right and whose direction of rotation is determined by the control electronics system, and actuation being performed in a half-wave-controlled manner.

The control element of a water deflector is adjusted by the position of the control element, that is to say its adjustment angle, being determined by a means and the adjustment angle being turned through the desired adjustment angle of the control element before the control element is adjusted by means of a synchronous motor which rotates to the left and right and is actuated in a half-wave-controlled manner and whose direction of rotation is prespecified by the control electronics system, so that the required throughflow rate of detergent can flow through the control element.

The third-mentioned object with respect to an apparatus is achieved, according to the invention, by the use of a single-phase synchronous motor, which rotates to the left and right and has two connections, for adjusting an adjustment device for a control element of a water deflector for a water-bearing household appliance.

In an advantageous development, the synchronous motor is designed without an auxiliary winding. A synchronous motor without an auxiliary winding provides the advantages of firstly being cost-effective to produce and secondly of being easy to actuate.

In a preferred alternative, the control electronics system determines the direction of rotation of the synchronous motor and actuation is performed in a half-wave-controlled manner.

The control element of the water deflector is easy to adjust on account of the direction of rotation being determined by the control electronics system and the synchronous motor being actuated in a half-wave-controlled manner.

In a further embodiment, the means for transmitting the rotation of the synchronous motor to the control element has a shaft.

A step-up or step-down gear mechanism is advantageously arranged between the synchronous motor and the control element, it being possible to use said gear mechanism to increase or, if necessary, reduce the rotation speed of the control element.

The means for ascertaining the position of the control element is expediently connected to the control system of the synchronous motor via a signal line. A wire-bound signal line or a wire-free signal line, that is to say transmission by electromagnetic waves, can advantageously be used to transmit the control signals.

In a further refinement, the means for ascertaining the position of the control element is a synchronization switch and a control disc which is connected to the control element in a rotationally fixed manner. The control disc may be a cam disc by means of which the synchronization switch is operated. The control disc may, for example like the control element, be arranged in a rotationally fixed manner on a shaft and therefore be turned through the same adjustment angle as the control element.

The means for ascertaining the position of the control element is advantageously a sensor for a parameter of the household appliance. One advantage of ascertaining the position of the control element using a sensor is the ability to electronically evaluate the sensor signal using the control electronics system, and cost-effective analysis of the state is therefore possible. Sensors may be understood as meaning both physical sensors and also current or voltage being ascertained.

In a particularly advantageous development of the apparatus, the parameter of the household appliance is the throughflow rate of water in the detergent circuit and/or the pressure in the detergent circuit and/or the current consumption of the pump which drives the detergent circuit. Measurement of the current consumption is particularly expedient since no additional sensors are required for this and the tap for determining the current consumption can be arranged on the printed circuit board of the control system.

In an advantageous development, the control element of the water deflector is surrounded by a housing which has an inflow and an outflow for the detergent circuit. The housing ensures that a defined throughflow can be set in conjunction with the control element and therefore the adjustment angle can be determined too.

In a preferred alternative, the control element has a number of openings of different sizes for setting different throughflow states.

In a further embodiment, the control element is in the form of a disc or in the form of a pipe with radially arranged openings.

For the method for adjusting a control element of a water deflector, the adjustment angle of the control element is advantageously determined by means of a control disc which interacts with a synchronization switch and is synchronized with the control element.

The adjustment angle of the control element is expediently determined by means of a sensor for determining the throughflow rate of water in the detergent circuit and/or the pressure in the detergent circuit and/or the current consumption of the pump which drives the detergent circuit.

Other features which are considered as characteristic for the invention are set forth in the appended claims.

Although the invention is illustrated and described herein as embodied in adjustment apparatus for a control element of a water deflector, method for adjustment and use of a synchronous motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF DRAWING

FIG. 1 shows a schematic illustration of an adjustment apparatus according to the invention; and

FIG. 2 is a schematic view illustrating the method steps for adjusting the water deflector according to the invention.

### DETAILED DESCRIPTION OF THE INVENTION

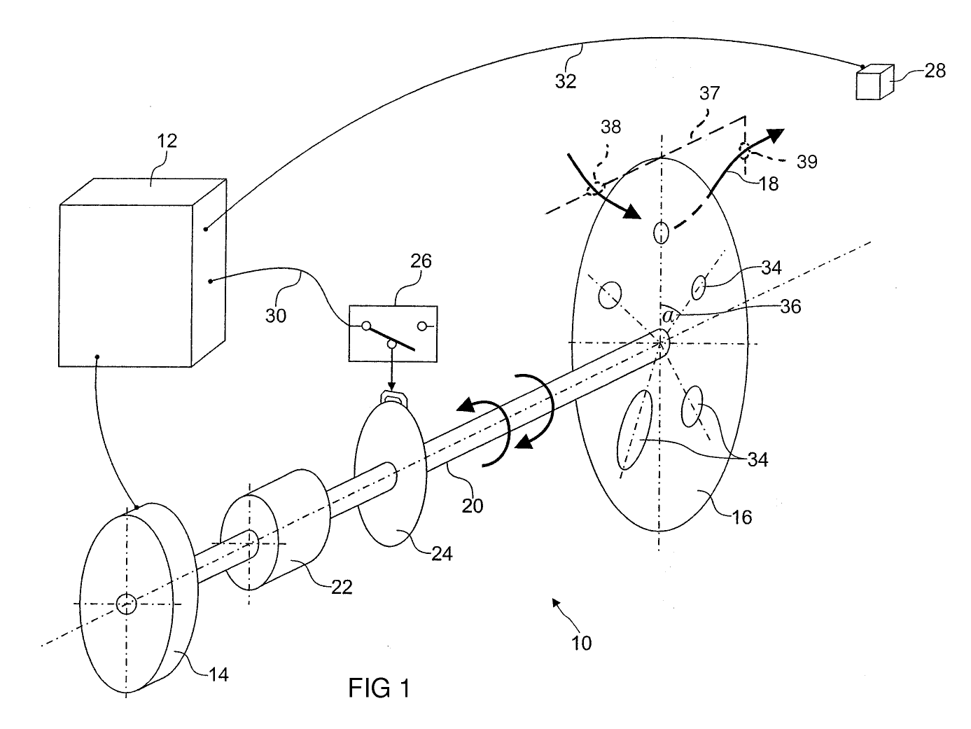

Referring now to the figures of the drawing in detail and first, particularly, to FIG. 1 thereof, there is shown a schematic view of an adjustment apparatus 10 for a control element 16 of a water deflector of a water-bearing household appliance. The adjustment apparatus 10 has a synchronous motor 14 which is connected to the control element 16, which is disposed in a housing 37 (indicated only schematically), by way of a shaft 20. The shaft 20 transmits a direction of rotation of the electric motor 14 to the control element 16 and moves an adjustment angle 36 of the control element 16. In the present example, a gear mechanism 22 is arranged on the shaft 20 of the adjustment device 10. Here, the gear mechanism 22 may be configured as a step-down or step-up gear transmission.

The control element 16 has a number of openings 34 of different sizes in order to influence a throughflow rate of a detergent circuit 18. The water inflow through an inlet 38 into the housing 37 and the water outflow through the outlet 39 from the housing 37 is indicated by arrows. Provision is made to combine a water inflow with a water outflow or, in a preferred alternative, to combine a water inflow with at least two water outflows, it being possible for the at least two water outflows to be fed through different openings 34.

The electric motor 14 is a single-phase synchronous motor which rotates to the left and to the right, has two connections, is designed without an auxiliary winding and is actuated in a half-wave-controlled manner. A control electronics system 12 actuates the synchronous motor 14, prespecifies its direction of rotation and adjusts the control element 16.

Means 24, 26, 28 for ascertaining the position of the control element are provided in order to ascertain the adjustment angle 36 of the control element 16. These means 24, 26, 28 for ascertaining the control element may be a control disc 24 which is connected to the control element 16 in a rotationally fixed manner, preferably by means of the shaft 20, and interacts with a synchronization switch 26. The adjustment angle 36 of the control element 16 can be determined by way of the control electronics system 12 as a function of the position of the synchronization switch 26. The control electronics system 12 is connected to the synchronization switch 26 via a signal line 30 in order to transmit the signal of the synchronization switch 26. The signal line 30 may be a wired or it may be a wireless connection signal line.

A sensor 28 for determining a parameter of the household appliance can be used as an alternative or in addition to the control disc 24 and the synchronization switch 26. The sensor 28 may be a throughflow rate meter in the detergent circuit, a pressure gauge in the detergent circuit and a measurement apparatus for determining the current consumption of the pump which drives the detergent circuit 18. Depending on the requirement for accuracy, these sensors can be used individually or in different combinations with one another. The sensor signal of the sensor 28 can be transmitted to the control electronics system 12 via a signal line 32. The said signal line may be a wire-bound or a wire-free signal line.

On account of the reversible actuation of the synchronous motor 14, the direction of rotation can be reversed from right to left, for example, and the control element 16 can therefore be moved in the forward and backward direction of rotation and the adjustment angle 36 can therefore be set. By virtue of this particularly advantageous refinement, it is possible to save time when running through the washing program since the waiting time during adjustment of the control element 16 can be considerably shortened as a result of the reversible direction of rotation. As an alternative to this, it is possible to use an electric motor 14 of substantially smaller design while maintaining the washing program duration as a result of a slower change in the adjustment angle 36 of the control element 16. The smaller design requires less material and therefore permits considerably reduced component costs.

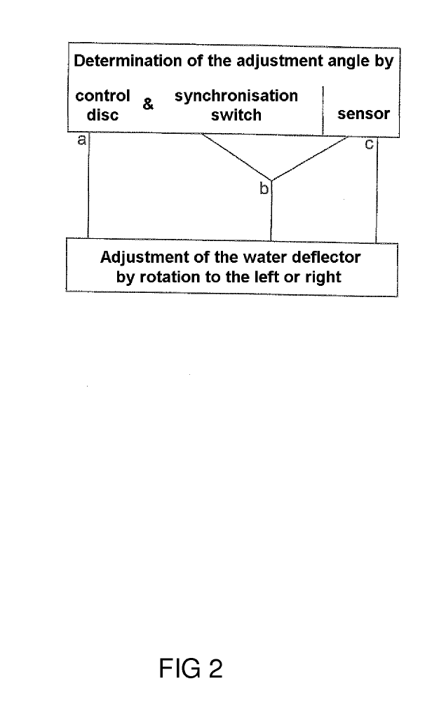

FIG. 2 illustrates the method steps for adjusting an adjustment device for a control element of a water deflector for a water-bearing household appliance. The adjustment angle 36 of the control element 16 is first determined by a means 24, 26, 28 for ascertaining the position of the control element 16. The said means may be a sensor 28 for determining the machine parameters or a control disc 24 in combination with a synchronization switch 26. The adjustment angle 36 can optionally be determined exclusively by the control disc 24 and the synchronization switch 26 or by the sensor 28, but also by combining the two means 24, 26, 28 for determining the adjustment angle 36. As a result of the adjustment angle 36 which is ascertained by the control electronics system 12, the control element 16 of the water deflector is then adjusted by rotation to the left or right of the synchronous motor 14 which is actuated in a half-wave-controlled manner by the control electronics system 12.

1. An adjustment apparatus for a control element of a water deflector of a water-bearing household appliance, comprising:
a single-phase synchronous electric motor configured to rotate to the left and to the right and having two connections, and a control electronics system connected to and actuating said electric motor to selectively turn to the left and to the right;
a water deflector with a control element for influencing a detergent circuit in the water-bearing household appliance;
a transmission device connected for transmitting a rotation of said electric motor to said control element; and
means connected to said control electronics system for ascertaining a position of said control element.

2. The adjustment apparatus according to claim 1, wherein said electric motor is a synchronous motor without an auxiliary winding.

3. The adjustment apparatus according to claim 1, wherein said control electronics system is configured to determine a direction of rotation of said electric motor and to actuate said electric motor by half-wave-control.

4. The adjustment apparatus according to claim 1, wherein said transmission device for transmitting the rotation of said electric motor to said control element has a shaft.

5. The adjustment apparatus according to claim 1, which further comprises a step-up or step-down gear mechanism disposed between said electric motor and said control element.

6. The adjustment apparatus according to claim 1, which comprises a signal line connecting said means for ascertaining the position of said control element to said control electronics system of said electric motor.

7. The adjustment apparatus according to claim 6, wherein said means for ascertaining the position of said control element is a synchronization switch and a control disc connected to said control element in a rotationally fixed manner.

8. The adjustment apparatus according to claim 6, wherein said means for ascertaining the position of said control element is a sensor for a parameter of the household appliance.

9. The adjustment apparatus according to claim 8, wherein the parameter of the household appliance is at least one parameter selected from the group consisting of a throughflow rate of water in the detergent circuit, a pressure in the detergent circuit, and a current consumption of a pump driving the detergent circuit.

10. The adjustment apparatus according to claim 1, which comprises a housing surrounding said control element of the water deflector, said housing having an inflow opening and an outflow opening for the detergent circuit.

11. The adjustment apparatus according to claim 1, wherein said control element is formed with a plurality of openings of mutually different sizes for setting different throughflow rates.

12. The adjustment apparatus according to claim 11, wherein said control element is a disc formed with said openings.

13. The adjustment apparatus according to claim 11, wherein said control element is a pipe with said openings formed radially.

14. A method for adjusting a control element of a water deflector for a water-bearing household appliance, which comprises:
providing an adjustment apparatus according to claim 1;
determining an adjustment angle of the control element with the means for ascertaining the position of the control element;
adjusting the control element by rotating the control element with a synchronous motor rotating to the left and the right and determining a direction of rotation with the control electronics system, and thereby actuating the synchronous motor in a half-wave-controlled manner.

15. The method according to claim 14, which comprises determining the adjustment angle of the control element by way of a control disc disposed to interact with a synchronization switch and synchronized with the control element.

16. The method according to claim 14, which comprises determining the adjustment angle of the control element based on at least one parameter selected from the group consisting of a throughflow rate of water in the detergent circuit, a pressure in the detergent circuit, and a current consumption of a pump driving the detergent circuit.

17. In a water-bearing household appliance, a method of adjusting a control element of a water deflector, which comprises: providing a single-phase synchronous motor, which rotates to the left and right and has two connections, and adjusting an adjustment device for the control element by selectively rotating the single-phase synchronous motor to the left and to the right.
